(19) United States
(12) Patent Application Publication
(10) Pub. No.: US 2004/0112553 A1
(43) Pub. Date: Jun. 17, 2004

(54) Compressible insert assembly

(76) Inventor: Walter Minnich, Delaware, OH (US)

Correspondence Address: Angenehm Law Firm, Ltd., P.O. Box 48755, Coon Rapids, MN, 55448-0755, US

(21) Appl. No.: 10/654,197

(22) Filed: Sep. 2, 2003

Related U.S. Application Data
(60) Provisional application No. 60/407,916, filed on Sep. 3, 2002.

(51) Int. Cl. E06B 3/30

(52) U.S. Cl. 160/378

(57) ABSTRACT

A window covering, including an insert including a top rail and a bottom rail joined to at least two side rails, the insert including a front face a back face and an outer periphery; a first sheet spanning the front face and joined to each of the rails, opposing rails being rotatable in opposite directions to tension the sheet and the rails being lockable to prevent loosening of the sheet; and a sealer circumscribing an outer periphery of the insert and a method of manufacture including the steps of removing the first sheet from the insert; replacing the first sheet with a new sheet; tensioning the new sheet; and placing the insert into the window frame.

### FIELD OF THE INVENTION

The invention relates to a window insert, and more particularly to a removable and selectively interchangable screen or storm window, claiming priority from provisional patent application 60/407,916, dated Sep. 3, 2002 and entitled COMPRESSIBLE INSERT ASSEMBLY.

### BACKGROUND OF THE INVENTION

Storm window have been utilized for many years in an effort to reduce drafts and the substantial loss of energy, heat or cooling, through inefficient windows. Such storm windows are commonly formed from a transparent shield, such as glass or plexiglass, which is held in places with a frame, commonly formed of aluminum. The sotrm window is held in place with fasteners such as screws or nails that damage the existing frame, allowing dirt and moisture to penetrate the protective paint barrier.

Typical storm windows require considerable labor and generally must be purchased to size. The frames may be adjustable in size, but generally to a small degree, e.g. within an inch. Thus, the installer must take measurements, go obtain the storm windows. Match each window to the proper sill and begin installation. Stores must carry a wide variety of sizes to fit all the different sized widows for which a customer may wish to purchase a storm. This uses up floor space and accordingly increases the price charged.

Should the user wish to change from a storm window to a screen, perhaps in the Spring or Summertime, the user either needs to purchase a multi-paneled storm window or switch storms. Such convenience further adds to the complexity and expense or typical storm windows.

What is needed is a storm window that can be cut to size an assembled at the job site to eliminate the need for pre-measuring and minimize floor space needed to display the storms at the store. As a further measure to reduce needed floor space, the window pane should be flexible, bendable perhaps to the point of being creasable such that it may be packaged as a small roll. The storm window should be easy to construct and easy to insert into a window frame to minimize time and effort. Desirably, the storm window should be held in place without the need for fasteners that penetrate into the window frame, avoiding destruction and introducing deterioration to the window frame. The frame should allow for tensioning or tightening of the sheet, e.g. window pane, to remove any bends or creases and provide an even smooth surface when installed. The frame should secure the sheet against slippage that could cause later wrinkles. Ideally, the window would allow for easy changing of a non-porous pane with a screen the reverse to allow the user to determine whether or not they desire fresh air. As a further desired feature, the sheet shoul be strong, such that it is not easily broken or shattered.

### SUMMARY OF THE INVENTION

The present window covering is provided with an insert, a first sheet an a sealer. The insert includes a top rail and a bottom rail joined to at least two side rails. The insert has a front face a back face and an outer periphery. The first sheet spans the front face and joins to each of the rails. Opposing rails are rotatable in opposite directions to tension the sheet. The opposing rails are lockable to prevent loosening of the sheet. The sealer circumscribes an outer periphery of the insert.

The method of making a window covering includes the steps of joining a top rail, a bottom rail and at least to side rails to form an insert; securing a first sheet to the insert; tensioning the sheet; and placing the insert into a window frame.

The invention as described is an insert for placement into an existing window opening. The insert is a frame sized to fit within an existing window opening so that the frame will fit closely against the frame and seal against the frame. The frame is covered on at least one side with a sheet that restricts or prevents the entry of an environmental agent.

In one form of the invention, the sheet is a transparent sheet of a polymer that allows the transmission of light, but, prevents the transmission of air. Here the insert is used to close the window opening or to add at least one layer of “dead” air as an insulative barrier for the structure. This form may be interchanged into other forms.

For instance, another form of the invention has the sheet perforated, such as, screening and allows the transmission of both air and light. Here the insert will allow light and breezes to pass through the window while preventing the entry of insects and other animals.

In a third form, the sheet may be colored to provide partially to completely blocked light and to provide tinting in the case of partial light blockage.

In yet another form, multiple sheets may be used to form multiple air pockets for insulation value.

### BRIEF DESCRIPTION OF THE DRAWINGS

FIG. 1 is a perspective view of the insert illustrating the insert proximate a window frame assembly;

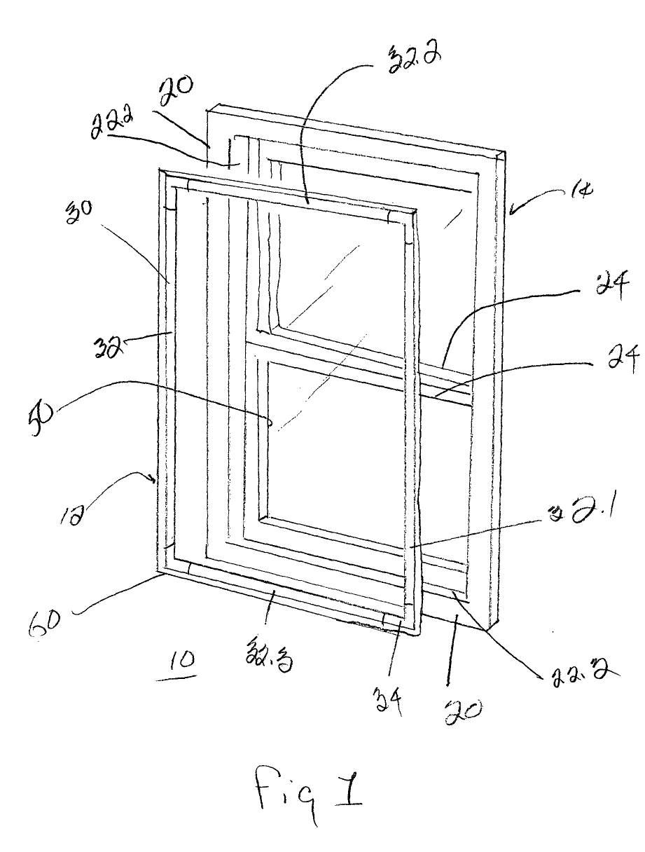

FIG. 2 is partial cut-away view of the frame of the insert showing the construction of the insert in the area of the frame;

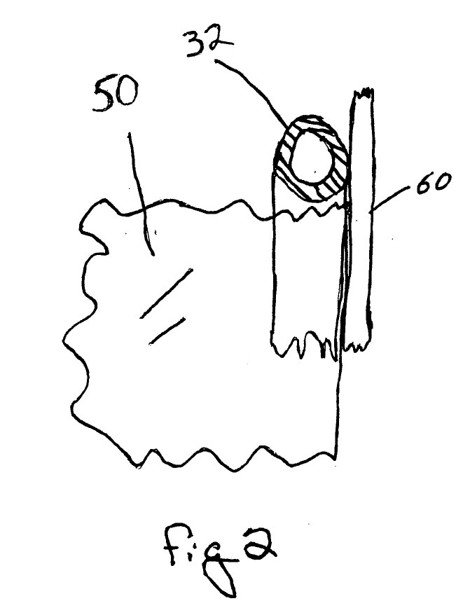

FIG. 3 is partial cut-away view showing the construction of the corners of the frame of the insert; and

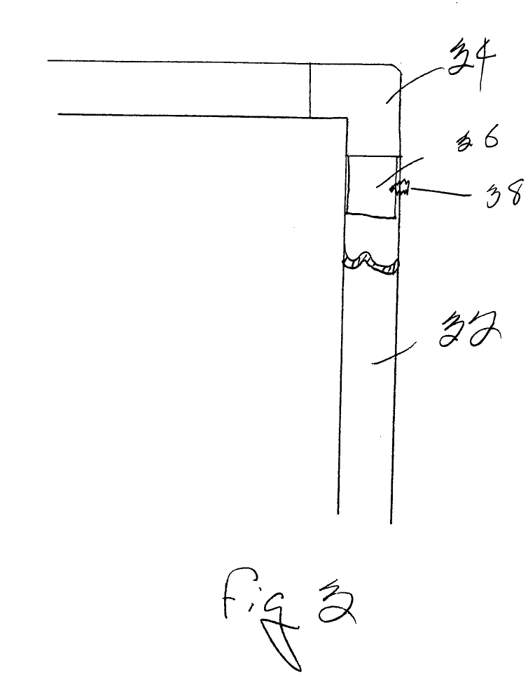

FIG. 4 is a plan view of an insert showing the triangulating braces.

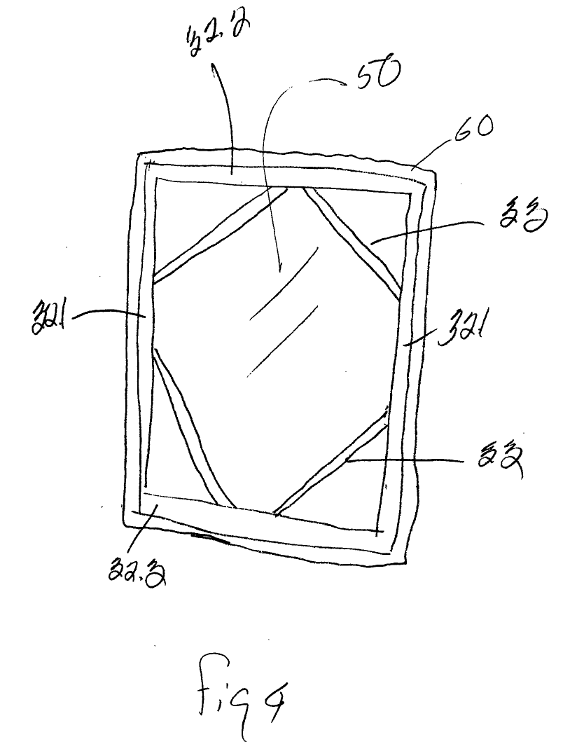

### DESCRIPTION OF THE PREFERRED EMBODIMENT

The frame insert assembly 10 has an insert 12 for fitment within a frame 14. The frame 14 may be, typically, an existing window mounted in an existing wall of a building. The frame 14 is conventional in construction and may include trim molding 20 mounted to the jams 22 of the frame 14. The frame 14 may have a movable sash 24 or perhaps, as illustrated, a double hung window having two movable sashes 24. As is conventional, the frame 14 has a head jam 22.1, two side jams 22.2 and a base jam or stool 22.3.

The insert 12 has a frame 30 with rails 32, including side rails 32.1, a top rail 32.2, and a bottom rail 32.3. At the junction of any two rails 32 there is a corner 34. The corner 34 serves the function of connecting and locating a pair of adjacent rails 32. Each rail 32 is attached at each respective end to a corner 34 using a suitable mechanism. The respective rails 32 and corners 34 should have substantially the same outer dimension so that the junction between a rail 32 and a corner 34 is fairly smooth and not stepped at the juncture of the rail 32 and the corner 34.

The rails 32 and corners 34 may be constructed from any suitable material having the properties of having sufficient stiffness or rigidity without becoming brittle, being relatively inexpensive, and being workable. Suitable materials would include various plastics or polymers, metals, and wood. The rails 32 and corners 34 may be of any suitable cross-sectional shape such as round or square tube, bar stock, or a decorative shape. The preferred material for construction of the rails 32 and corners 34 is PVC or CPVC having a round cross section which is readily available from numerous well known suppliers.

In a preferred mode, the rails 32 and corners 34 may be constructed of PVC or CPVC pipe with the corners 34 being 90 degree elbows. Additionally with PVC piping, the outside diameter of ½ inch pipe is approximately 3/4 inch, which will provide an interference fit of 1/2 inch pipe into 3/4 inch pipe. This mode fortuitously allows the use of CPVC 1/2 inch, inside diameter, elbows as corners 34 and 1/2 inch inside diameter PVC pipe as rails 32, the corners 34 and rails 32 thence having substantially the same outside diameter. Similar advantages are found with materials of other sizes as well.

The joining of the rails 32 to the corners 34 may be accomplished with the use of a tenon 36. The tenon 36 is preferrably a short piece of 1/2 inch pipe that will slide into both the rail 32 and the corner 34. Preferably, the tenon 36 is fixedly joined to the corner 34 so that the tenon 36 cannot be inadvertently displaced destroying the integrity of the joint. While the tenons 36 may be joined to the corners 34 using any suitable mechanism such as gluing, fusing, or mechanical fasteners, it is preferred that the tenons 36 be joined to the corners 34 using the solvent or glue that is intended for the type of pipe being used for the corners 34 or rails 32. Such solvents or glues are readily available from the same vendors as the PVC or CPVC pipe. Above is illustrated, how to make the corners 34 from readily available pre-existing parts, but one skilled in the art knows that the corner 34 may be formed integrally with associates tenons 36 in a mold or by other processes.

A simple rectangle of rails 32 an corners 34 is often adequate to form the insert 12 for many applications. However, additional strength, beauty and/or insulation value may be acquired using additional bracing to stiffen the rails 32. The additional bracing may be provided, for example, with triangulators 33 which join a side rail 33.1 with an adjacent top rail 33.2 or bottom rail 32.3. The triangulators 33 may be additional sections of PVC pipe of the same material as the rails 32 and serve to prevent the bending of the rails 32 when tensioned and placed into a frame 14. Triangulators 33 may provide additional insulation value where a plurality of sheets 50 are joined to the insert 12 with the trangulators 33 disposed therebetween. The triangulators 33 reduce airflow within the airspaces, e.g., the triangulators 33 block and restrict the air flow, while creating air pockets within the triangulators 33.

A sheet 50 is attached using a suitable mechanism to one face of the rails 32 and extends across the opening formed by the rails 32 and corners 34. The sheet 50 provides the function of closing off the insert separating the inside from the outside. The sheet 50 may be attached to the rails 32 and corners 34 using any suitable mechanism such as glue or adhesives, mechanical fasteners such as staples, kerfing the rails 32 and corners 34 and attaching the sheet using a spline to hold the sheet 50 in the kerf. It is preferred, however, that the sheet 50 be attached to the rails 32 using an adhesive.

The sheet 50 may be any suitable separator that provides the intended separation of elements. In one example the sheet 50 is a transparent film that allows the passage of light and prevents airflow. In this use the insert 12 will function as a storm window in an existing window to increase the insulative properties of the window. In another example, the sheet 50 is a screen that allows airflow while preventing the entry of insects and other undesirable objects. Opaque films may be used to block light and air, while translucent films may be used to block air and allow partial light. One optional sheet 50 contemplated within the current invention is the joinder of pieces of translucent films of varying color in a pattern, such as a stained glass window, to form a mosaic. A preferred sheet 50 is sold by Phifer Wire Products, Inc. P.O. Box 1700 Tuscaloosa, Ala. 35403 under the trademark PETSCREEN. Such sheet 50 secured to the insert 12 in accordance with the teaching herein, remained unbroken when an adult of 200 plus pounds intentionally ran directly into the sheet 50, demonstrating the resiliency of the present storm window.

A resilient sealer 60 may be attached about the outer periphery of the insert 12, providing a seal between the insert 12 and the frame 14. The resilient sealer 60 may be a strip of an expanded polymer attached to the perimeter formed by the rails 32 and the corners 34. The insulating tape forming the sealer 60 may be of any suitable width, and is commonly 3/4 inch wide, similarly, the insulating tape forming the sealer 60 may be of any suitable thickness and is commonly 1/2 inch thick. It has been found that insulating foam commonly sold for insulating windows performs quite well. An additional advantage is that such insulating tape is readily available in pre-cut to suitable lengths and is faced on one side with a pressure sensitive adhesive to allow the sealer 60 to be attached to the perimeter of the insert 12. A suitable product is available from W. J. Dennis an Company (Elgin, Ill.). Alternatively, insulative pipe covering may be used to provide the seal.

The fabrication of the insert 12 preferably involves two separate processes. In the initial fabrication, an assembly is fabricated and packaged to produce the individual kits. Each kit is intended to for use in one window frame 14. With the fabrication, the corners 34 preformed with integral tenons 36 or are assembled by inserting and adhering the tenons 36 into the respective corners 34. There are four completed corners 34 being prepared for each assembly. A sheet 50 of suitable size and material is included with the kit and a suitable length of the resilient sealer 60 is included in the kit along with the necessary fasteners to connect the rails 32 to the corners 34. The fasteners may be any suitable fastener and are typically screws 38, the use of which will be explained later, and the adhesive which may be used to attach the sheet 50 to the rails 32. Each kit unit may then be packaged for distribution.

The second phase of fabrication involves construction and insertion of the insert 12. Prior to the actual use of the insert 12, the insert 12 must be sized and fitted to the actual frame 14. A user will measure the height and width of the selected frame 14. From these measurements, the user may cut the rails 32 to size. Usually, both of the side rails 32.1 will be the cut to the same length. Likewise, the top rail 32.2 and the bottom rail 32.3 will be cut to length. It is, however, understood that occasionally the frame 14 will not be an exact rectangle and it will become necessary to cut one of a pair of the rails 32 to a slightly different length to accommodate the out of square condition of the frame 14. Alternatively, the corners 34 may adjust slightly, allowing fine tuned adjustment.

After the rails 32 have been cut to length, the user may inserts the exposed ends of the tenons 36 into the rails 32 thus assembling the perimeter of the insert 12. The user may then place the assembled insert 12 into the frame 14 to test the fit. When a suitable fit has been obtained, the user may then proceed to install the sheet 50.

The user will then select an appropriate sheet 50. The user may select a screen type of sheet when the user intends airflow to be allowed through the window, or the user may select a polymer film sheet 50 when the user intends to prevent airflow through the window. A mosaic, preformed or user created, translucent films or other films may also be selected as sheet 50.

To install the sheet 50, the user may first select and when necessary prepare a suitable adhesive to secure the sheet 50 to the rails 32. The adhesive is spread onto the surface of the rails 32 and the selected sheet 50 is placed on and pressed into the adhesive and loosely stretched to remove wrinkles, etc. With the sheet 50 thus located on the rails 32, the adhesive may be allowed to cure. The time necessary for the adhesive to cure will be dependant on the composition of the adhesive used and may vary from a matter of seconds with a fast drying cyanoacrylic adhesive to a day with some of the slow curing adhesives.

After the adhesive has sufficiently cured, the sheet 50 may be stretched. The user selects one of a pair of opposing rails 32, for example, the bottom rail 32.3, and secures the rail 32.3. Various mechanisms may be used to rotationally secure a rail 32 to a tenon 36. The rail 32 may be secured to the corner 34 using adhesives, welding, fusing, or mechanical fasteners. Thus, when an adhesive is used, the rail 32 can be temporarily secured, perhaps with clamps, from rotation while the adhesive sets sufficiently to prevent further rotation of the rail 32. Adhesives, welding, or fusion are suitable and useful in a production application, however, it has been found that the preferred fastener for an end user to install is a simple wood or sheet metal screw.

With one rail 32.3 thus secured, the user may then rotate the opposing top rail 32.2 to stretch the sheet 50 and smooth the surface of the sheet 50. With the sheet 50 thus tensioned, the user may then secure the top rail 32.2.

A user to pre-drill holes for the insertion of the screws 38 through the rails 32 and into tenons 36. Alternatively, self-drilling screws 38 may obviate the need for the user to drill the rails 32 and tenons 36 to accept the screws 38. Most preferably, the rails 32 may hold the sheet 50 in a stretched position, held by clamps, while holes are drilled and screws inserted through the rails 32 and into tenons 36.

After tensioning in the first direction, the user would then follow the same steps rotating and securing the side rails 32.1 to provide the necessary tension in the second direction.

After the tensioning is complete, the user then can take the resilient sealer 60 and attach the sealer 60 to the perimeter of the insert 12. Using the preferred sealer, the user need only cut a strip of the sealer 60 to the approximate length of the perimeter of the insert 12, remove the tape exposing the pressure sensitive adhesive and press the sealer 60 onto the periphery of the insert 12 to join the sealer 60 to the insert 12. When all of the sides 32 of the insert 12 are covered, any excess of the sealer 60 may be cut away using a scissors or a knife. The insert 12 is now ready for placement in the frame 14. Instead of using sealer in the form of a tape, foam pipe insulation may be used. The foam, readily available in stores comes in lengths with a precut slit and interior channel which may be fit around the edges of the insert 12.

In some instances, where a user is attempting to minimize heat transfer through a window, it is advantageous to place a second sheet 50 of transparent material on the insert. At this time, however, the rails 32 cannot be rotated to tension the second sheet 50, so a different material must be used. The preferred material is a heat shrinkable transparent film. Material of the type is well know in the art and readily available from numerous sources, including 3M Company, St. Paul, Minn.

The heat shrinkable second sheet 50 may be placed over the insert 12 on the side that is not already covered, creating an air pocket, and secured using any suitable mechanism. Typically film of this type is sold with double faced pressure sensitive tape which allows the tape to be placed on and stick to the face or perimeter of the insert 12 and the film then placed on and retained by the second sticky surface of the tape.

After the second sheet 50 has been so placed and trimmed, if necessary, heat is applied to the second sheet 50 causing the sheet to shrink and tension the sheet 50 on the insert 12. Preferably, the heat source is a hot air source such as a heat gun or a gun type hair dryer.

When the user is preparing a large insert 12, which may include triangulators 33, the triangulators 33 are installed after the rails 32 have been tensioned and secured and before the optional second sheet 50 is placed on the insert.

The insert 12 is simply placed into the opening 14 and pressed in against the sashes 24 in the frame 14. In many instances, friction between the sealer 60 and the frame 14 is sufficient to retain the insert 12 in place. However, it may become necessary to further secure the insert 12 in some instances, owing to either limited friction between the sealer 60 and the frame 14 or for security concerns.

When the insert 12 must be further secured into the frame 14, this may be simple and expeditiously accomplished by drilling through two or more rails 32 and driving a screw 38 through the hole thus produced and into the jam 22. This process will secure the insert 12 so that the insert 12 will not inadvertently come out while allowing the user to intentionally remove the insert 12 and will further tighten the sheet 50.

Occasionally it may become necessary for the user to replace the sheet 50 or the sealer 60 due to damage. To replace the sheet 50, the user would first remover the sealer 60 from the insert 12 and would then reverse the process on installation previously described. After the sheet 50 had been removed, the user would select a replacement sheet 50 and install the sheet 50 in the same manner that the original sheet 50 had been installed.

Although the present invention has been described with reference to preferred embodiments, workers skilled in the art will recognize changes may be made in form and detail without departing from the spirit and scope of the invention

What is claimed:

1. A window covering, comprising:
an insert including a top rail, a bottom rail, at least two side rails and a plurality of tenons joined to corner members, the tenons joining rails to corner members, the insert including a front face a back face and an outer periphery;
a first sheet spanning the front face and joined to each of the rails, opposing rails being rotatable in opposite directions to tension the sheet and the rails being lockable to prevent loosening of the sheet;
at least one triangulator, each triangulator being joined to adjacent rails,
a second sheet joined to the back face, the triangulators being in contact with the first and second sheets; and
a sealer circumscribing an outer periphery of the insert.

2. A window covering, comprising:
an insert including a top rail and a bottom rail joined to at least two side rails, the insert including a front face a back face and an outer periphery;
a first sheet spanning the front face and joined to each of the rails, opposing rails being rotatable in opposite directions to tension the sheet and the rails being lockable to prevent loosening of the sheet; and
a sealer circumscribing an outer periphery of the insert.

3. The device of claim 2 wherein the first sheet is clear plastic.

4. The device of claim 2 wherein the first sheet is screening.

5. The device of claim 2 wherein the first sheet is opaque plastic.

6. The device of claim 2 wherein the first sheet is colored translucent plastic.

7. The device of claim 6 wherein the first sheet is a mosaic.

8. The device of claim 2 wherein screws lock the rails.

9. The device of claim 2 wherein a sheet is joined to the back face.

10. The device of claim 2 further comprising triangulators, wherein each triangulator is joined to adjacent rails.

11. The device of claim 10 wherein triangulators are joined to triangulators.

12. The device of claim 10 wherein a second sheet is joined to the back face and the triangulators are in contact with the first and second sheets.

13. The device of claim 2 wherein the sealer is foam pipe insulation.

14. The device of claim 2 further including a plurality of tenons joined to corner members, the tenons joining rails to corner members.

15. A method of making a window covering comprising the steps of:
joining a top rail, a bottom rail and at least to side rails to form an insert;
securing a first sheet to the insert;
tensioning the sheet; and
placing the insert into a window frame.

16. The method of claim 15 further comprising the steps of rotating opposing rails to tension the first sheet.

17. The method of claim 15 further comprising the step of:
connecting triangulators to adjacent rails.

18. The method of claim 15 further comprising the step of:
securing a second sheet to the insert on a side of the insert opposite the first sheet.

19. The method of claim 17 further comprising the step of:
securing a second sheet to the insert on a side of the insert opposite the first sheet.

20. The method of claim 15 further comprising the steps of:
removing the first sheet from the insert;
replacing the first sheet with a new sheet;
tensioning the new sheet; and
placing the insert into the window frame.
